(19) United States
(12) Patent Application Publication
(10) Pub. No.: US 2025/0034914 A1
(43) Pub. Date: Jan. 30, 2025

(54) STRIKER SYSTEM, VEHICLE COMPRISING A STRIKER SYSTEM AND METHOD FOR ASSEMBLING A STRIKER SYSTEM

(71) Applicants: Ningbo Geely Automobile Research & Development Co., Ltd., Ningbo (CN); Zhejiang Geely Holding Group Co., Ltd., Zhejiang (CN)

(72) Inventor: Kim HANSSON, Göteborg (SE)

(21) Appl. No.: 18/913,640

(22) Filed: Oct. 11, 2024

Related U.S. Application Data
(63) Continuation of application No. PCT/CN2023/090616, filed on Apr. 25, 2023.

(30) Foreign Application Priority Data
May 4, 2022 (EP) 22171677.2

(51) Int. Cl. E05B 79/02; E05B 85/04

(52) U.S. Cl. CPC E05B 79/02; E05B 85/04

(57) ABSTRACT

A striker system includes a striker and a bracket plate is arranged to attach the striker to a vehicle body via the bracket plate. The bracket plate has an extension in the longitudinal, lateral, and vertical directions, and has first and second elevated sections spaced apart from each other in the longitudinal direction. The bracket plate has first, second, and third attachment sections spaced apart from each other in the longitudinal direction and configured for attachment to the vehicle body. The first and second elevated sections respectively have a first and a second fastening member for engaging corresponding first and second fastening elements connecting the striker to the bracket plate. The first elevated section is arranged between and connected to the first attachment section and the second attachment section, and the second elevated section is arranged between and connected to the second attachment section and the third attachment section.

### RELATED APPLICATION DATA

This application is a continuation of International Patent Application No. PCT/CN2023/090616, filed Apr. 25, 2023, and claims the benefit of European Patent Application No. 22171677.2, filed May 4, 2022, the disclosures of which are incorporated herein by reference in their entireties.

### TECHNICAL FIELD

The present disclosure relates to a striker system for interaction with a vehicle door locking unit, where the striker system comprises a striker and a bracket plate. The striker system is arranged for attaching the striker to a vehicle body via the bracket plate. The disclosure further relates to a vehicle comprising a striker system and a method for assembling a striker system.

### BACKGROUND

Vehicle door locks are commonly used for locking a vehicle door to a vehicle body structure and for releasing the vehicle door from the vehicle body structure. The vehicle door locks often comprise a locking unit arranged in the vehicle door and a cooperating striker attached to the vehicle body structure, where the striker has a suitable shape, extension and configuration for cooperation with the locking unit. During the vehicle assembling process, it is important to attach the striker to the vehicle body structure with high precision for enabling a secure and reliable interaction with the locking unit in the vehicle door. Brackets arranged on the inside of the vehicle body structure may be used for receiving fastening elements that are attaching the striker to the vehicle body structure via the bracket.

One issue with current bracket solutions is the problem with adjustability of nuts when mounting the striker to the bracket with the fastening elements. Another issue is reduced adjustability of the brackets when the car body structures are undergoing electrocoating processes, where the coating is adhering to the brackets and are preventing or limiting the adjustability. When assembling the vehicle, these issues are leading to non-efficient and time-consuming striker mounting operations.

There is thus a need for an improved striker solution for fast and efficient attachment of the striker to the vehicle body structure during the vehicle assembly process.

### SUMMARY

An object of the present disclosure is to provide a striker system, a vehicle comprising a striker system, and a method for assembling a striker system, where the previously mentioned problems are avoided. This object is at least partly achieved by the features of the independent claims. The dependent claims contain further developments of the striker system.

The disclosure concerns a striker system comprising a striker and a bracket plate, and the striker system is arranged for attaching the striker to a vehicle body via the bracket plate in an assembled state. The bracket plate has an extension in a longitudinal direction, a lateral direction and a vertical direction, and comprises a first elevated section and a second elevated section spaced apart from each other in the longitudinal direction. The bracket plate further comprises a first attachment section, a second attachment section and a third attachment section spaced apart from each other in the longitudinal direction and configured for being attached to the vehicle body in an attached state. The first elevated section comprises a first fastening member configured for engaging a corresponding first fastening element connecting the striker to the bracket plate. The second elevated section comprises a second fastening member configured for engaging a corresponding second fastening element connecting the striker to the bracket plate. The first elevated section is arranged between and connected to the first attachment section and the second attachment section, and the second elevated section is arranged between and connected to the second attachment section and the third attachment section.

Advantages with these features are improved adjustability of the fastening members when mounting the striker to the bracket plate with the fastening elements. The separated elevated sections are allowing an efficient individual adjustment of the fastening members. The adjustability of the bracket plate when the car body structures are undergoing electrocoating processes is efficiently maintained through the arrangement of the spaced apart elevated sections and the attachment sections, preventing coating that is adhering to the elevated sections during the electrocoating process is blocking the individual adjustability of the elevated sections. With the striker system, the striker mounting operations can be made more efficient and less time-consuming.

In one embodiment, the first elevated section is connected to the first attachment section via one or more first deformation elements. The first elevated section is connected to the second attachment section via one or more second deformation elements. The second elevated section is connected to the second attachment section via one or more third deformation elements. The second elevated section is connected to the third attachment section via one or more fourth deformation elements. The deformation elements are allowing the respective elevated sections with corresponding fastening members to be floatingly suspended and individually adjustable upon assembling of the striker system, for an efficient mounting operation.

In one embodiment, the one or more first deformation elements and the one or more second deformation elements are upon deformation allowing the first elevated section with the first fastening member to be floatingly suspended and individually adjustable. The one or more third deformation elements and the one or more fourth deformation elements are upon deformation allowing the second elevated section with the second fastening member to be floatingly suspended and individually adjustable. The one or more first deformation elements and the one or more second deformation elements are enabling the floatingly suspended and individually adjustable arrangement of the first elevated section upon deformation of the deformation elements. The one or more third deformation elements and the one or more fourth deformation elements are enabling the floatingly suspended and individually adjustable arrangement of the second elevated section upon deformation of the deformation elements. The deformation elements are thus when being deformed allowing the elevated sections to move individually for a precise alignment of the elevated sections relative to the striker.

In one embodiment, the first elevated section is adjustable in the longitudinal direction, lateral direction and/or vertical direction through deformation of the one or more first deformation elements and/or the one or more second deformation elements. The second elevated section is adjustable in the longitudinal direction, lateral direction and/or vertical direction through deformation of the one or more third deformation elements and/or the one or more fourth deformation elements. The adjustability in different directions are enabling a fast mounting operation of the striker with high precision.

In one embodiment, the one or more first deformation elements are arranged as structural elements integrated with the first elevated section and the first attachment section. The one or more second deformation elements are arranged as structural elements integrated with the first elevated section and the second attachment section. The one or more third deformation elements are arranged as structural elements integrated with the second elevated section and the second attachment section. The one or more fourth deformation elements are arranged as structural elements integrated with the second elevated section and the third attachment section. The integrated configurations are enabling an efficient production process of the bracket plate, where the bracket plate may be cut out from one single piece of material and thereafter formed into the desired shape.

In one embodiment, the bracket plate comprises two or more first deformation elements spaced apart in the lateral direction of the bracket plate, two or more second deformation elements spaced apart in the lateral direction of the bracket plate, two or more third deformation elements spaced apart in the lateral direction of the bracket plate, and two or more fourth deformation elements spaced apart in the lateral direction of the bracket plate. The spaced apart configurations are allowing the elevated sections to be easily adjusted in different positions.

In one embodiment, in the assembled state, the first elevated section is brought in contact with the vehicle body through deformation of the one or more first deformation elements and the one or more second deformation elements. In the assembled state, the second elevated section is brought in contact with the vehicle body through deformation of the one or more third deformation elements and the one or more fourth deformation elements. The one or more first deformation elements and the one or more second deformation elements are enabling the floatingly suspended and individually adjustable arrangement of the first elevated section upon deformation of the deformation elements, and when the first fastening element is tightened the first elevated section is brought into contact with the vehicle body. The one or more third deformation elements and the one or more fourth deformation elements are enabling the floatingly suspended and individually adjustable arrangement of the second elevated section upon deformation of the deformation elements, and when the second fastening element is tightened the second elevated section is brought into contact with the vehicle body. The deformation elements are when being deformed allowing the elevated sections to move individually for a precise alignment of the elevated sections relative to the striker.

In one embodiment, the first attachment section, the second attachment section and the third attachment section are arranged on a first level in the vertical direction of the bracket plate. In the attached state, the first elevated section and the second elevated section are arranged on a second level in the vertical direction of the bracket plate different from the first level.

In one embodiment, in the attached state, the first attachment section, the second attachment section and the third attachment section are arranged in connection to the vehicle body. The first elevated section and the second elevated section are arranged at a distance from the vehicle body in the vertical direction of the bracket plate. The arrangement of the first elevated section and the second elevated section at a distance from the vehicle body in the vertical direction of the bracket plate is enabling the efficient individual adjustment of the fastening members, as well as the maintained adjustability of the bracket plate when the car body structures are undergoing electrocoating processes.

In one embodiment, in the assembled state, the striker is arranged on a first side of a vehicle body element, and the bracket plate is arranged on a second side of the vehicle body element.

In one embodiment, the striker comprises a striker plate arranged in contact with the first side in the assembled state. The striker plate comprises a first fastening opening arranged for receiving the first fastening element and a second fastening opening arranged for receiving the second fastening element. In the assembled state, the first fastening element is extending from the first side to the second side via the first fastening opening, a first opening in the vehicle body element and the first fastening member. In the assembled state, the second fastening element is extending from the first side to the second side via the second fastening opening, a second opening in the vehicle body element and the second fastening member. The openings in the vehicle body are enabling the assembling of the striker system, where the fastening elements are allowed to extend through the vehicle body from the first side of the vehicle body element to the second side of the vehicle body element.

In one embodiment, in the assembled state, the first elevated section and the second elevated section are arranged in contact with the second side of the vehicle body element. When the first elevated section and the second elevated section are arranged in contact with the second side of the vehicle body element, the bracket plate is efficiently securing the striker to the vehicle body.

In one embodiment, in the attached state, the bracket plate is connected to the vehicle body. The first attachment section is attached to the vehicle body via one or more first attachment members, the second attachment section is attached to the vehicle body via one or more second attachment members, and the third attachment section is attached to the vehicle body via one or more third attachment members. The attachment members are used for a strong connection between the respective attachment sections and the vehicle body.

In one embodiment, the one or more first attachment members, the one or more second attachment members, and the one or more third attachment members, are arranged as welds. The welds are providing an efficient and strong connection between the attachment sections and the vehicle body.

In one embodiment, the first fastening member is arranged as a first weld nut welded to an outer side of the first elevated section, and the second fastening member is arranged as a second weld nut welded to an outer side of the second elevated section. The use of weld nuts are providing a strong connection to the elevated sections, where welds are used for efficiently attaching the weld nuts to the elevated sections.

The disclosure further concerns a vehicle comprising a striker system as described above.

The disclosure further concerns a method for assembling a striker system, as described above, into an assembled state. The method comprises the steps: arranging the bracket plate in connection to the vehicle body in an attached state, where the first attachment section, the second attachment section and the third attachment section are attached to the vehicle body, and where the first elevated section and the second elevated section are arranged at a distance from the vehicle body in the vertical direction; engaging the first fastening element to the striker, and to the first fastening member of the first elevated section via the vehicle body, and engaging the second fastening element to the striker, and to the second fastening member of the second elevated section via the vehicle body, for connecting the striker to the bracket plate; tightening the first fastening element for bringing the first elevated section in contact with the vehicle body through deformation of one or more first deformation elements connecting the first elevated section to the first attachment section and one or more second deformation elements connecting the first elevated section to the second attachment section, and tightening the second fastening element for bringing the second elevated section in contact with the vehicle body through deformation of one or more third deformation elements connecting the second elevated section to the second attachment section and one or more fourth deformation elements connecting the second elevated section to the third attachment section.

Advantages with the method are improved adjustability of the fastening members when mounting the striker to the bracket plate with the fastening elements. The separated elevated sections are allowing an efficient individual adjustment of the fastening members through the deformation elements. The adjustability of the bracket plate when the car body structures are undergoing electrocoating processes is efficiently maintained through the arrangement of the spaced apart elevated sections, and the attachment sections, preventing that the coating is adhering to the elevated sections. With the striker system, the striker mounting operations can be made more efficient and less time-consuming. The deformation elements are allowing the respective elevated section with corresponding fastening member to be floatingly suspended and individually adjustable upon assembling of the striker system. The one or more first deformation elements and the one or more second deformation elements are enabling the floatingly suspended and individually adjustable arrangement of the first elevated section upon deformation of the deformation elements, when the first fastening element is tightened for bringing the first elevated section in contact with the vehicle body. The one or more third deformation elements and the one or more fourth deformation elements are enabling the floatingly suspended and individually adjustable arrangement of the second elevated section upon deformation of the deformation elements, when the second fastening element is tightened for bringing the second elevated section in contact with the vehicle body. The deformation elements are when being deformed allowing the elevated sections to move individually for a precise alignment of the elevated sections relative to the striker.

### BRIEF DESCRIPTION OF THE DRAWINGS

The disclosure will be described in detail in the following, with reference to the attached drawings, in which

FIG. 1 shows schematically, a side view of a vehicle comprising a striker system, according to the disclosure,

FIG. 2 shows schematically, a rear view of the vehicle comprising a striker system, according to the disclosure,

FIG. 3 shows schematically, a perspective view of a bracket plate of the striker system in an attached state before an assembled state, according to the disclosure,

FIG. 4 shows schematically, a perspective view of the bracket plate, according to the disclosure,

FIG. 5 shows schematically, a rear view of the bracket plate, according to the disclosure,

FIG. 6 shows schematically, a side view of the bracket plate in the attached state before the assembled state, according to the disclosure,

FIGS. 7A-7E show schematically, side views of the striker system in different assembling positions and in an assembled state, according to the disclosure, and

FIGS. 8A-8B show schematically, side views of the striker system in an assembling position and in the assembled state, according to the disclosure.

### DETAILED DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

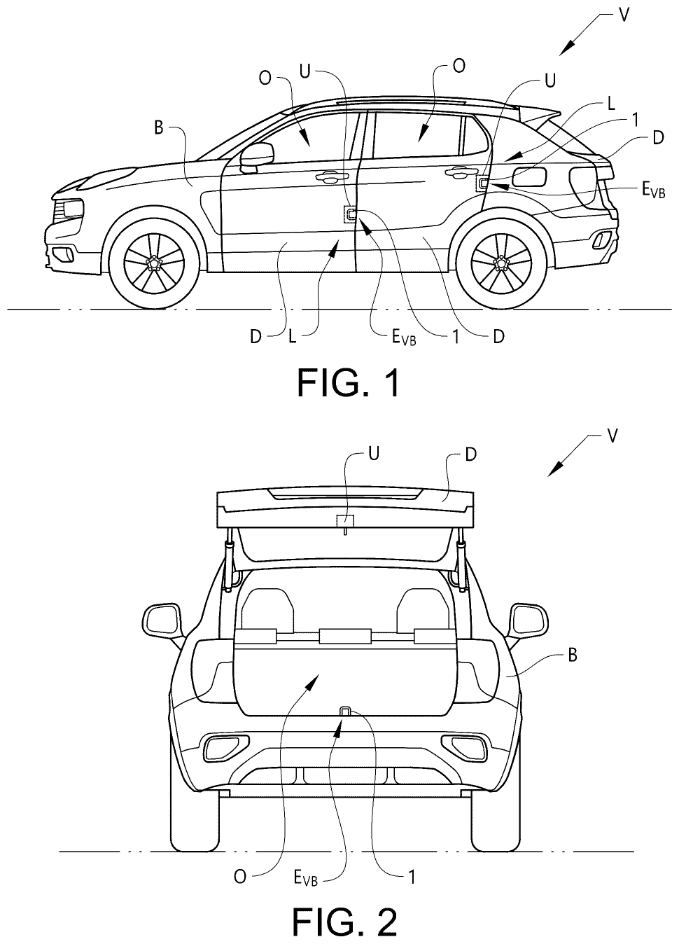

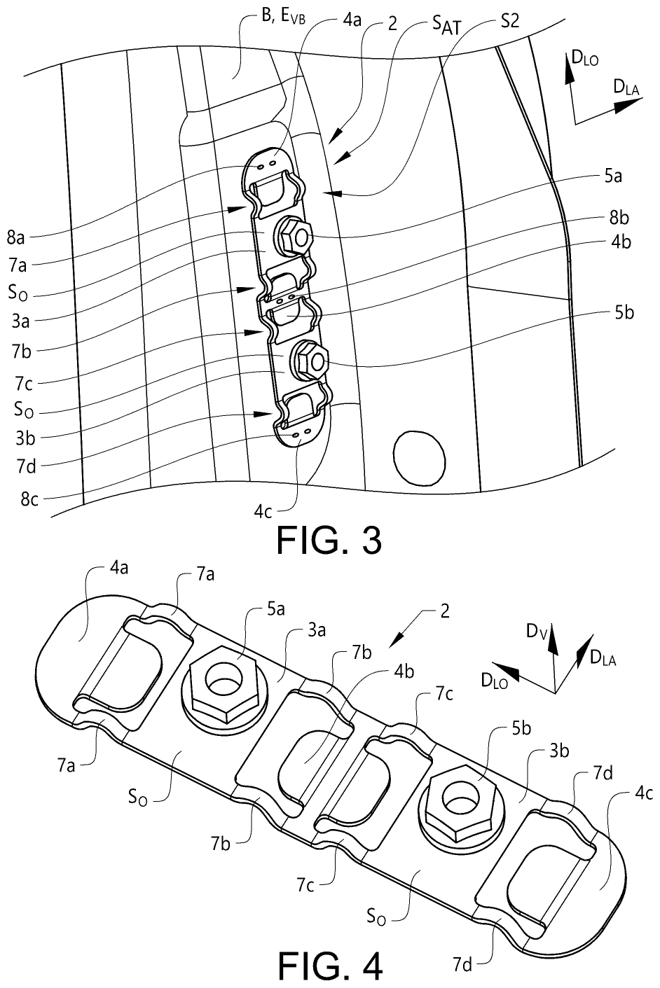

FIGS. 1-2 schematically show a vehicle V with vehicle doors D, where the vehicle doors D are movably arranged relative to a vehicle body B of the vehicle V. In FIG. 1, two side doors are illustrated, and in FIG. 2, a rear door is illustrated. The vehicle doors D can each be displaced between a closed door position and open door positions in any conventional manner.

As further shown in FIGS. 1-2, a vehicle door lock L is arranged in connection to each vehicle door D and a corresponding door opening O of the vehicle V. The vehicle door lock L comprises a locking unit U arranged in the vehicle door D and a cooperating striker 1 attached to a vehicle body element E_{VB} forming a structural part of the vehicle body B. The striker 1 may have any suitable shape, extension or configuration for cooperation with the locking unit U, such as for example a traditional loop-like or U-like configuration with two connected shafts, as indicated in for example FIGS. 1-2. The locking unit U is interacting with the striker 1 for locking the vehicle door D to the vehicle body B and for releasing the vehicle door D from the vehicle body B. The vehicle body element E_{VB} may be any suitable part of the vehicle body B for attachment of the striker system S, such as for example a section of an A-pillar, B-pillar, C-pillar, or any other suitable structural part of the vehicle body B for vehicle doors D arranged as side doors. When the vehicle door D is arranged as a rear door, the vehicle body element E_{VB} may for example be a lower beam structure, D-pillar, or any other suitable structural part of the vehicle body B for vehicle doors D arranged as rear doors. The selected vehicle body element E_{VB} may vary for different vehicle constructions depending on the design and constructional features of the vehicle door D.

In the open door positions, the locking unit U is disengaged from the striker 1, allowing the vehicle door D to being displaced for giving access to an interior compartment of the vehicle V. In the closed door position, the locking unit U is engaging the striker 1, preventing the vehicle door D from being displaced to an open door position. The locking unit U of the vehicle door D is suitably provided with a locking member, such as a latch mechanism or similar arrangement, for engaging and disengaging the striker 1. The locking unit U is suitably actuated via a door handle in a conventional manner for opening the vehicle door D and disengaging the locking member from the striker 1. When closing the vehicle door D, the locking member is configured for engaging the striker 1 to hold the vehicle door D in the closed door position. More specifically, an outer end of the striker 1 is configured for interacting with the locking unit U of the vehicle door D for releasably connecting the vehicle door D to the vehicle body B.

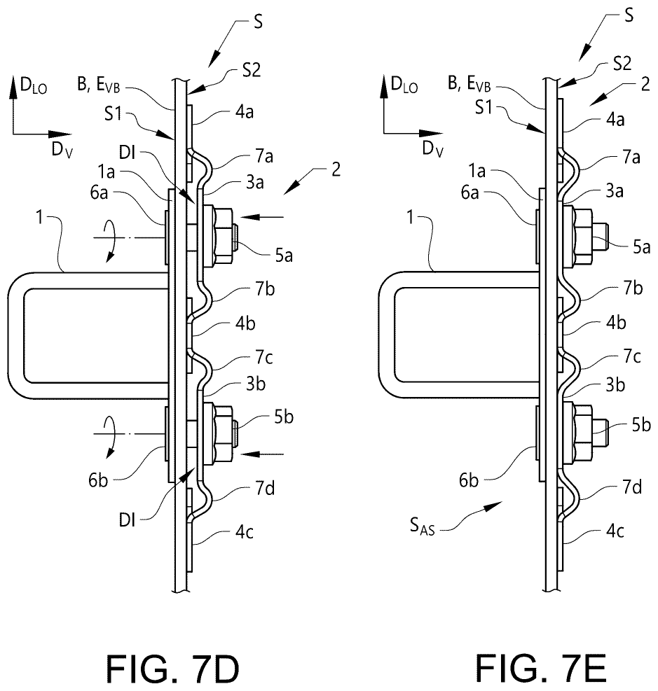

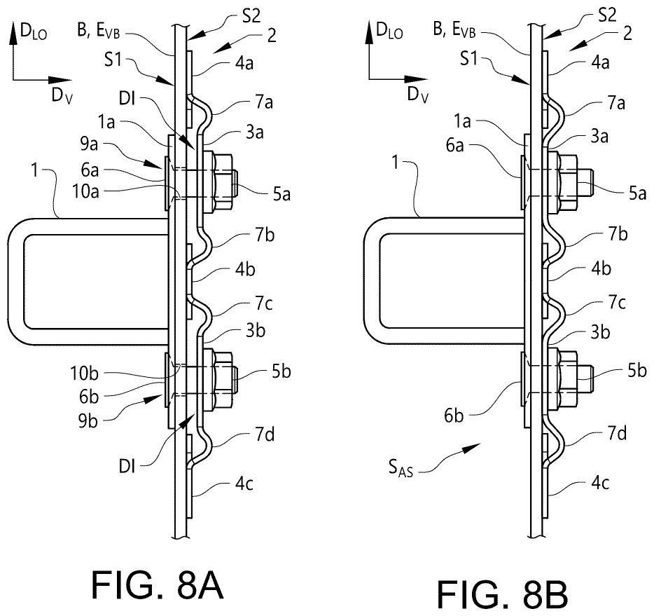

The striker 1 is forming part of a striker system S. The striker system S comprises the striker 1 and a bracket plate 2, as for example illustrated in FIGS. 7A-7E, and the striker system S is arranged for attaching the striker 1 to the vehicle body B via the bracket plate 2 in an assembled state S_{AS}. The assembled state S_{AS} of the striker system S is shown in FIGS. 7E and 8B, and is the state in which the striker 1 is securely mounted to the vehicle V via the bracket plate 2 for interaction with the locking unit U in the vehicle door D.

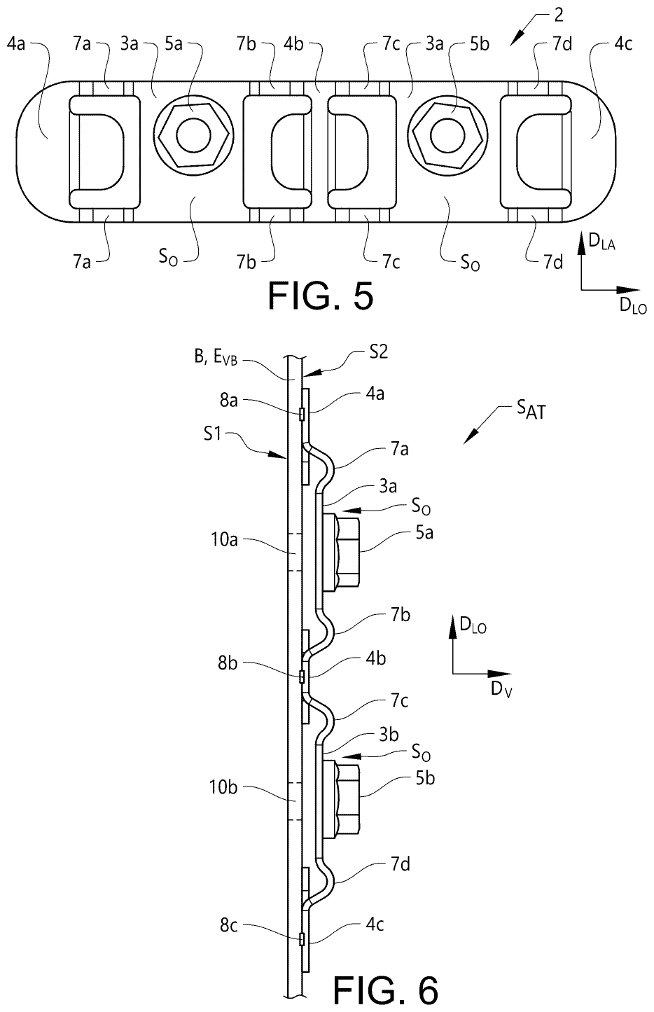

The bracket plate 2 is illustrated more in detail in FIGS. 3-6. The bracket plate 2 has an extension in a longitudinal direction D_{LO}, a lateral direction D_{LA} and a vertical direction D_{V}, and comprises a first elevated section 3a and a second elevated section 3b spaced apart from each other in the longitudinal direction D_{LO}. The bracket plate 2 further comprises a first attachment section 4a, a second attachment section 4b and a third attachment section 4c spaced apart from each other in the longitudinal direction D_{LO}. The first attachment section 4a, second attachment section 4b and third attachment section 4c are configured for being attached to the vehicle body element E_{VB} forming the structural part vehicle body B in an attached state S_{AT}, as shown in for example FIGS. 3, 6 and 7C.

As shown in FIGS. 3-6, the first elevated section 3a is arranged between and connected to the first attachment section 4a and the second attachment section 4b. The second elevated section 3b is arranged between and connected to the second attachment section 4b and the third attachment section 4c. The first elevated section 3a is connected to the first attachment section 4a via one or more first deformation elements 7a. The first elevated section 3a is connected to the second attachment section 4b via one or more second deformation elements 7b. The second elevated section 3b is connected to the second attachment section 4b via one or more third deformation elements 7c. The second elevated section 3b is connected to the third attachment section 4c via one or more fourth deformation elements 7d. The configuration and purpose of the deformation elements will be further described below.

As illustrated in for example FIGS. 3-6, 7A-7E, and 8A-8B, the first elevated section 3a comprises a first fastening member 5a and the second elevated section 3b comprises a second fastening member 5b. The first fastening member 5a is configured for engaging a corresponding first fastening element 6a. The second fastening member 5b is configured for engaging a corresponding second fastening element 6b. The respective first fastening element 6a and second fastening element 6b are connecting the striker 1 to the bracket plate 2 through cooperating engagement with the first fastening member 5a and the second fastening member 5b.

The first fastening element 6a and the second fastening element 6b are suitably arranged as screws, and the first fastening member 5a and the second fastening member 5b are suitably arranged as nuts, as schematically illustrated in the figures. The fastening elements are in a conventional manner provided with external threads that are engaging inner threads of the fastening members for a secure and efficient connection of the striker 1 to the bracket plate 2. It should however be understood that other suitable fastening members and fastening elements may be used.

The first fastening member 5a is suitably arranged as a first weld nut welded to an outer side S_{O} of the first elevated section 3a, and the second fastening member 5b as a second weld nut welded to an outer side S_{O} of the second elevated section 3b. The first fastening member 5a and the second fastening member 5b may be pre-attached to the bracket plate 2 through welding. The pre-attachment step is indicated with arrows in FIG. 7A and the attached fastening members are schematically shown in FIG. 7B. In other embodiments, the first fastening member and the second fastening member may have other suitable configurations for engaging the first and second fastening elements respectively. In an alternative non-illustrated embodiment, the first fastening member and the second fastening member may instead be arranged as threaded holes arranged in the first elevated section 3a and the second elevated section 3b respectively.

When assembling the striker system S, it is desired that the respective elevated sections with corresponding fastening members are floatingly suspended and individually adjustable for an efficient mounting operation. This is efficiently enabled by the deformation elements, and the adjustability of the fastening members when mounting the striker 1 to the bracket plate 2 with the fastening elements is improved compared to traditional solutions. The separation of the first elevated section 3a and the second elevated section 3b are allowing an efficient individual adjustment of the fastening members when being connected to the fastening elements.

The one or more first deformation elements 7a and the one or more second deformation elements 7b are upon deformation allowing the first elevated section 3a with the first fastening member 5a to be floatingly suspended and individually adjustable when mounting the striker 1 to the vehicle body B. The first elevated section 3a is adjustable in the longitudinal direction D_{LO}, lateral direction D_{LA} and/or vertical direction D_{V} through deformation of the one or more first deformation elements 7a and/or the one or more second deformation elements 7b. In the illustrated embodiment, the one or more first deformation elements 7a are arranged as structural elements integrated with the first elevated section 3a and the first attachment section 4a, and the one or more second deformation elements 7b are arranged as structural elements integrated with the first elevated section 3a and the second attachment section 4b.

The one or more third deformation elements 7c and the one or more fourth deformation elements 7d are upon deformation allowing the second elevated section 3b with the second fastening member 5b to be floatingly suspended and individually adjustable when mounting the striker 1 to the vehicle body B. The second elevated section 3b is adjustable in the longitudinal direction D_{LO}, lateral direction D_{LA} and/or vertical direction D_{V} through deformation of the one or more third deformation elements 7c and/or the one or more fourth deformation elements 7d. In the illustrated embodiment, the one or more third deformation elements 7c are arranged as structural elements integrated with the second elevated section 3b and the second attachment section 4b, and the one or more fourth deformation elements 7d are arranged as structural elements integrated with the second elevated section 3b and the third attachment section 4c.

With the term integrated is meant that the deformation elements may form a structurally integrated part of the respective elevated sections and attachment sections. The bracket plate 2 may for example be cut out from a single piece of material, such as for example aluminum, steel, or other suitable metals, and the deformation elements are then formed from the same piece of material as the elevated sections and attachment sections. In other embodiments, the bracket plate 2 may for example formed from a plurality of pieces of material, such as for example aluminum, steel, or other suitable metals, and the deformation elements may be formed from separate pieces of material that are attached to the elevated sections and attachment sections to form the structurally integrated configuration. In other embodiments, the deformation elements may be formed from the same piece of material as the elevated sections and attached to the attachment sections, and/or from the same piece of material as the attachment sections and attached to the elevated sections. The deformation elements may in the latter embodiments when attached to another piece of material, or other pieces of material, for example be welded to the elevated sections and/or the attachment sections.

The bracket plate 2 comprises two or more first deformation elements 7a spaced apart in the lateral direction D_{LA} of the bracket plate 2, and two or more second deformation elements 7b spaced apart in the lateral direction D_{LA} of the bracket plate 2. Further, the bracket plate 2 comprises two or more third deformation elements 7c spaced apart in the lateral direction D_{LA} of the bracket plate 2, and two or more fourth deformation elements 7a spaced apart in the lateral direction D_{LA} of the bracket plate 2. Any suitable number of deformation elements may be used depending on the construction and design of the bracket plate 2.

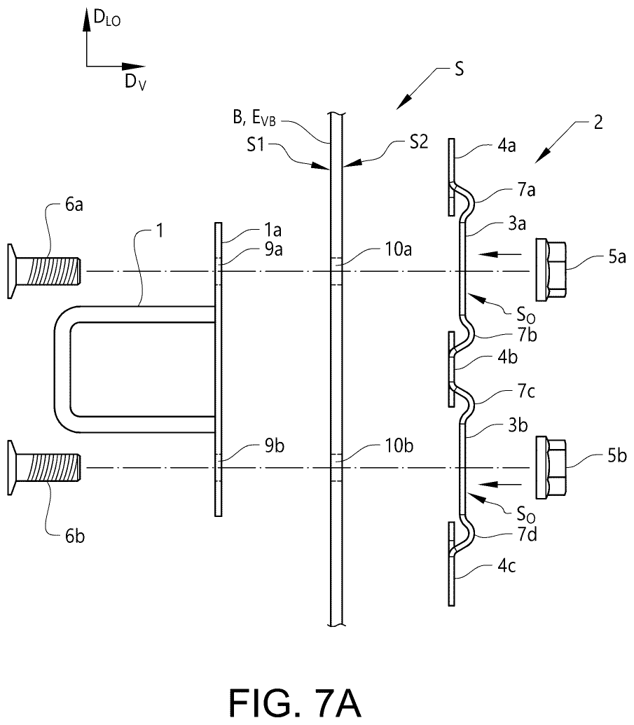

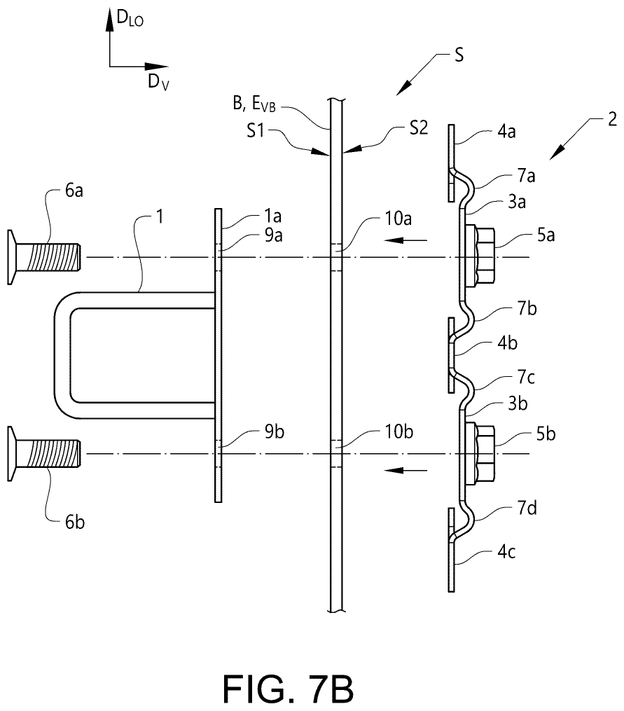

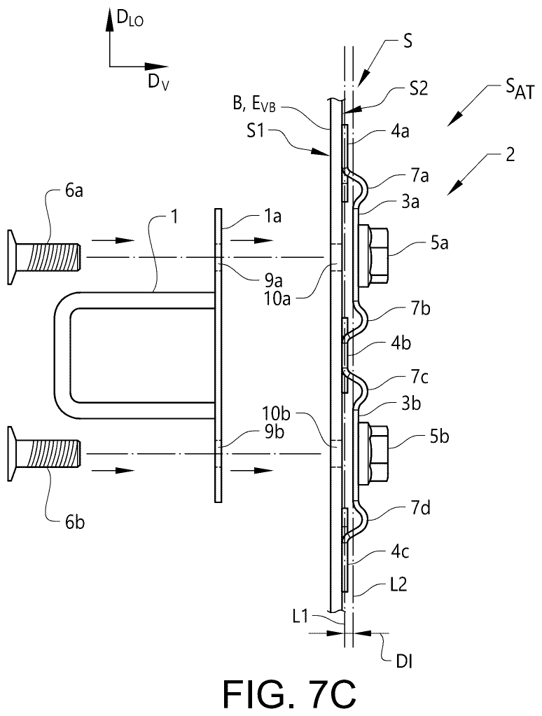

In the embodiment illustrated in FIGS. 3-6, the bracket plate 2 comprises two first deformation elements 7a spaced apart in the lateral direction D_{LA} of the bracket plate 2. The first deformation elements 7a are connecting the first elevated section 3a to the first attachment section 4a at opposite lateral sides of the bracket plate 2, and the extension of each of the first deformation elements 7a in the lateral direction D_{LA} is smaller than the extensions in the lateral direction D_{LA} of the first elevated section 3a and the first attachment section 4a, as understood from for example FIG. 5. The first deformation elements 7a are having curved configurations in the vertical direction, as understood from for example FIGS. 4 and 6. It should however be understood that the first deformation elements 7a may have any other suitable shape and configuration.

In the embodiment illustrated in FIGS. 3-6, the bracket plate 2 comprises two second deformation elements 7b spaced apart in the lateral direction D_{LA} of the bracket plate 2. The second deformation elements 7b are connecting the first elevated section 3a to the second attachment section 4b at opposite lateral sides of the bracket plate 2, and the extension of each of the second deformation elements 7b in the lateral direction D_{LA} is smaller than the extensions in the lateral direction D_{LA} of the first elevated section 3a and the second attachment section 4b, as understood from for example FIG. 5. The second deformation elements 7b are having curved configurations in the vertical direction, as understood from for example FIGS. 4 and 6. It should however be understood that the second deformation elements 7b may have any other suitable shape and configuration.

In the embodiment illustrated in FIGS. 3-6, the bracket plate 2 comprises two third deformation elements 7c spaced apart in the lateral direction D_{LA} of the bracket plate 2. The third deformation elements 7c are connecting the second elevated section 3b to the second attachment section 4b at opposite lateral sides of the bracket plate 2, and the extension of each of the third deformation elements 7c in the lateral direction D_{LA} is smaller than the extensions in the lateral direction D_{LA} of the second elevated section 3b and the second attachment section 4b, as understood from for example FIG. 5. The third deformation elements 7c are having curved configurations in the vertical direction, as understood from for example FIGS. 4 and 6. It should however be understood that the third deformation elements 7c may have any other suitable shape and configuration.

In the embodiment illustrated in FIGS. 3-6, the bracket plate 2 comprises two fourth deformation elements 7d spaced apart in the lateral direction D_{LA} of the bracket plate 2. The fourth deformation elements 7d are connecting the second elevated section 3b to the third attachment section 4c at opposite lateral sides of the bracket plate 2, and the extension of each of the fourth deformation elements 7d in the lateral direction D_{LA} is smaller than the extensions in the lateral direction D_{LA} of the second elevated section 3b and the third attachment section 4c, as understood from for example FIG. 5. The fourth deformation elements 7d are having curved configurations in the vertical direction, as understood from for example FIGS. 4 and 6. It should however be understood that the fourth deformation elements 7d may have any other suitable shape and configuration.

As described above, the first attachment section 4a, second attachment section 4b and third attachment section 4c are configured for being attached to the vehicle body element E_{VB} forming the structural part of the vehicle body B, in the attached state S_{AT}, as shown in for example FIGS. 3, 6 and 7C. In the attached state S_{AT}, the bracket plate 2 is suitably firmly connected to the vehicle body B for an efficient assembly of the striker system S. In the illustrated embodiment, the first attachment section 4a is attached to the vehicle body B via one or more first attachment members 8a, the second attachment section 4b is attached to the vehicle body B via one or more second attachment members 8b, and the third attachment section 4c is attached to the vehicle body B via one or more third attachment members 8c. The one or more first attachment members 8a, the one or more second attachment members 8b, and the one or more third attachment members 8c, are suitably arranged as welds for a firm and secure connection between the bracket plate 2 and the vehicle body B. Any suitable number of welds may be used for the connection. In other non-illustrated embodiments, the attachment members may instead be arranged as rivets or screws that are connecting the bracket plate 2 to the vehicle body B.

In the attached state S_{AT}, the first attachment section 4a, the second attachment section 4b and the third attachment section 4c are arranged in connection to the vehicle body B, as shown in for example FIGS. 3, 6 and 7A, through the attachment with the attachment members described above. The first elevated section 3a and the second elevated section 3b are in the attached state S_{AT} before deformation of the deformation elements and before assembling the striker system S into the assembled state S_{AS}, arranged at a distance DI from the vehicle body B in the vertical direction D_{V} of the bracket plate 2. The attached state S_{AT} before assembling the striker system S into the assembled state S_{AS} is schematically illustrated in FIGS. 6 and 7C. Thus, when the bracket plate 2 is in the attached state but not yet connected to the striker 1 in the assembled state S_{AS}, there is a gap between the vehicle body B and the respective elevated section, allowing the elevated sections to be floatingly suspended and individually adjustable for an efficient assembly operation of the striker system S. The adjustability of the bracket plate when the car body structure is undergoing an electrocoating process is efficiently maintained through the arrangement of the spaced apart elevated sections at the distance DI from the car body B. The distance DI is efficiently preventing coating that may adhere to the elevated sections during the electrocoating process is blocking the individual adjustability of the elevated sections.

The first attachment section 4a, the second attachment section 4b and the third attachment section 4c are arranged on a first level L1 in the vertical direction D_{V} of the bracket plate 2. In the attached state S_{AT}, the first level L1 is arranged in close connection to the vehicle body B through the attachment of the attachment sections to the vehicle body B. In the attached state S_{AT} before deformation of the deformation elements and before assembling the striker system S into the assembled state S_{AS}, the first elevated section 3a and the second elevated section 3b are arranged on a second level L2 in the vertical direction D_{V} of the bracket plate 2 different from the first level L1, as shown in FIG. 7C.

In the assembled state S_{AS}, as shown in FIGS. 7E and 8B, the first elevated section 3a is brought in contact with the vehicle body B through deformation of the one or more first deformation elements 7a and the one or more second deformation elements 7b. The second elevated section 3b is in the assembled state S_{AS} brought in contact with the vehicle body B through deformation of the one or more third deformation elements 7c and the one or more fourth deformation elements 7d.

As further shown in FIGS. 7E and 8B, in the assembled state S_{AS}, the striker 1 is arranged on a first side S1 of a vehicle body element E_{VB}, and the bracket plate 2 is arranged on a second side S2 of the vehicle body element E_{VB}.

As shown in FIGS. 7A-7E and 8A-8B, the striker 1 comprises a striker plate 1a. The striker plate 1a is arranged in contact with the first side S1 in the assembled state S_{AS}. The striker plate 1a comprises a first fastening opening 9a arranged for receiving the first fastening element 6a and a second fastening opening 9b arranged for receiving the second fastening element 6b. In the assembled state S_{AS}, the first fastening element 6a is extending from the first side S1 to the second side S2 via the first fastening opening 9a, a first opening 10a in the vehicle body element E_{VB} and the first fastening member 5a. In the assembled state S_{AS}, the second fastening element 6b is extending from the first side S1 to the second side S2 via the second fastening opening 9b, a second opening 10b in the vehicle body element E_{VB} and the second fastening member 5b.

In the assembled state S_{AS}, the first elevated section 3a and the second elevated section 3b are arranged in contact with the second side S2 of the vehicle body element E_{VB}, as shown in FIGS. 7E and 8B.

It should be understood that the attachment of the bracket plate 2 in the attached state S_{AT} described above is maintained in the assembled state S_{AS}, for a firm connection of the bracket plate 2 to the vehicle body B.

To assemble the striker system S into the assembled state S_{AS}, the different components needed are provided from a suitable source. Thereafter the first fastening member 5a is attached to the first elevated section 3a, and the second fastening member 5b is attached to the second elevated section 3b, as indicated with arrows in FIG. 7A. In this way, the bracket plate 2 and the fastening members are forming a structural unit, as shown in for example FIG. 7B, that can be easily stored and later attached to the vehicle body structure B during the vehicle assembly process. The bracket plate 2 comprising the first fastening member 5a and the second fastening member 5b is attached is attached to the vehicle body element E_{VB} of the vehicle body B, as indicated with arrows in FIG. 7B into the attached state S_{AT} illustrated in FIG. 7C. In the attached state S_{AT}, the bracket plate 2 is suitably arranged in direct connection to the second side S2 of the vehicle body element E_{VB}, and the first attachment section 4a, the second attachment section 4b and the third attachment section 4c are attached to the vehicle body element E_{VB} of the vehicle body B for a firm connection between the bracket structure 2 and the vehicle body element E_{VB}. In the attached state, the first fastening element 5a is suitably aligned with the first opening 10a in the vehicle body element E_{VB}, and the second fastening element 5b is suitably aligned with the second opening 10b in the vehicle body element E_{VB}, as understood from for example FIG. 7C. In the attached state S_{AT}, before deformation of the deformation elements and before assembling the striker system S into the assembled state S_{AS}, the first elevated section 3a and the second elevated section 3b are arranged at the distance DI from the second side S2 of the vehicle body element E_{VB} in the vertical direction D_{V}, as described above. When the bracket plate 2 is attached to the second side S2 of the vehicle body element E_{VB} with for example welds or other attachment means the vehicle body B may undergo electrocoating processes.

To mount the striker 1 to the bracket plate 2, the striker plate 1a of the striker 1 is arranged in connection to the first side S1 of the vehicle body element E_{VB}, as understood from FIGS. 7C-7D. The first fastening opening 9a of the striker plate 1a is aligned with the first opening 10a in the vehicle body element E_{VB}, and the second fastening opening 9b is aligned with the second opening 10b in the vehicle body element E_{VB}, as understood from for example FIGS. 7C-7D. For connecting the striker 1 to the bracket plate 2, the first fastening element 6a is thereafter engaging the first fastening member 5a of the first elevated section 3a via the first fastening opening 9a of the striker plate 1a and the first opening 10a of the vehicle body element E_{VB}, and the second fastening element 6b is engaging the second fastening member 5b of the second elevated section 3b via the second fastening opening 9b of the striker plate 1a and the second opening 10b of the vehicle body element E_{VB}. As understood from FIGS. 7D and 8A, the first fastening element 6a is threaded into the first fastening member 5a and the second fastening element 6b is threaded into the second fastening member 5b, for connecting the striker 1 to the bracket plate 2. The first fastening element 6a is extending from the first side S1 to the second side S2 via the first fastening opening 9a and the first opening 10a into the first fastening member 5a, and the second fastening element 6b is extending from the first side S1 to the second side S2 via the second fastening opening 9b and the second opening 10b into the second fastening member 5b. The position illustrated in FIGS. 7D and 8A is only an intermediate assembling position, where the first fastening element 6a and the second fastening element 6b are only threaded into the respective first fastening member 5a and second fastening member 5b without being tightened. In this intermediate assembling position, the fastening elements have entered the corresponding fastening members and the elevated sections are still arranged at the distance DI from the vehicle body element E_{VB}, as shown in FIGS. 7D and 8A.

When the first fastening element 6a is threaded into the first fastening member 5a, the first fastening element 6a is tightened for bringing the first elevated section 3a in contact with the vehicle body B through deformation of the first deformation elements 7a connecting the first elevated section 3a to the first attachment section 4a and deformation of the second deformation elements 7b connecting the first elevated section 3a to the second attachment section 4b, as illustrated in FIGS. 7E and 8B. The deformation of the first deformation elements 7a and the second deformation elements 7b are enabling the individual adjustment and floating suspension of the first elevated section 3a with the first fastening member 5a when the first fastening element 6a is tightened. During the tightening of the first fastening element 6a, the first elevated section 3a with the first fastening member 5a is displaced in the vertical direction D_{V} towards the second side S2, and during the tightening operation the first elevated section 3a with the first fastening member 5a is further allowed to move in the longitudinal direction D_{LO} and lateral direction D_{LA} if needed through the deformation of the first deformation elements 7a and the second deformation elements 7b, for an efficient positioning and alignment of the first fastening element 6a and first fastening member 5a relative to each other, as shown in FIGS. 7E and 8B.

When the second fastening element 6b is threaded into the second fastening member 5b, the second fastening element 6b is tightened for bringing the second elevated section 3b in contact with the vehicle body B through deformation of the third deformation elements 7c connecting the second elevated section 3b to the second attachment section 4b and deformation of the fourth deformation elements 7d connecting the second elevated section 3b to the third attachment section 4c, as illustrated in FIGS. 7E and 8B. The deformation of the third deformation elements 7c and the fourth deformation elements 7d are enabling the individual adjustment and floating suspension of the second elevated section 3b with the second fastening member 5b when the second fastening element 6b is tightened. During the tightening of the second fastening element 6b, the second elevated section 3b with the second fastening member 5b is displaced in the vertical direction D_{V} towards the second side S2, and during the tightening operation the second elevated section 3b with the second fastening member 5b is further allowed to move in the longitudinal direction D_{LO} and lateral direction D_{LA} if needed through the deformation of the third deformation elements 7c and the fourth deformation elements 7d, for an efficient positioning and alignment of the second fastening element 6b and second fastening member 5b relative to each other, as shown in FIGS. 7E and 8B.

In the assembled state S_{AS}, illustrated in FIGS. 7E and 8B, the striker system S is fully assembled and ready for use.

It should be understood that in other non-illustrated embodiments, the striker system could be arranged with a bracket plate comprising more than two elevated sections and/or more than three attachment sections. Further, more than two fastening members and corresponding fastening elements may be used for attaching the striker to the bracket plate, depending on the design and configuration of the striker system.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description. Reference signs mentioned in the claims should not be seen as limiting the extent of the matter protected by the claims, and their sole function is to make claims easier to understand.

### REFERENCE SIGNS

1: Striker
1a: Striker plate
2: Bracket plate
3a: First elevated section
3b: Second elevated section
4a: First attachment section
4b: Second attachment section
4c: Third attachment section
5a: First fastening member
5b: Second fastening member
6a: First fastening element
6b: Second fastening element
7a: First deformation element
7b: Second deformation element
7c: Third deformation element
7d: Fourth deformation element
8a: First attachment member
8b: Second attachment member
8c: Third attachment member
9a: First fastening opening
9b: Second fastening opening
10a: First opening
10b: Second opening
B: Vehicle body
D: Vehicle door
DI: Distance
D_{LA}: Lateral direction
D_{LO}: Longitudinal direction
D_{V}: Vertical direction
E_{VB}: Vehicle body element
L: Vehicle door lock
L1: First level
L2: Second level
O: Door opening
S: Striker system
S_{AS}: Assembled state
S_{AT}: Attached state
S_{O}: Outer side
U: Locking unit
V: Vehicle

What is claimed is:

1. A striker system comprising a striker and a bracket plate, wherein the striker system is arranged for attaching the striker to a vehicle body via the bracket plate in an assembled state,
wherein the bracket plate has an extension in a longitudinal direction, a lateral direction and a vertical direction, and comprises a first elevated section and a second elevated section spaced apart from each other in the longitudinal direction,
wherein the bracket plate further comprises a first attachment section, a second attachment section and a third attachment section spaced apart from each other in the longitudinal direction and configured for being attached to the vehicle body in an attached state,
wherein the first elevated section comprises a first fastening member configured for engaging a corresponding first fastening element connecting the striker to the bracket plate, wherein the second elevated section comprises a second fastening member configured for engaging a corresponding second fastening element connecting the striker to the bracket plate,
wherein the first elevated section is arranged between and connected to the first attachment section and the second attachment section, and wherein the second elevated section is arranged between and connected to the second attachment section and the third attachment section.

2. The striker system according to claim 1, wherein the first elevated section is connected to the first attachment section via one or more first deformation elements, wherein the first elevated section is connected to the second attachment section via one or more second deformation elements, wherein the second elevated section is connected to the second attachment section via one or more third deformation elements, and wherein the second elevated section is connected to the third attachment section via one or more fourth deformation elements.

3. The striker system according to claim 2, wherein the one or more first deformation elements and the one or more second deformation elements upon deformation are allowing the first elevated section with the first fastening member to be floatingly suspended and individually adjustable;
wherein the one or more third deformation elements and the one or more fourth deformation elements upon deformation are allowing the second elevated section with the second fastening member to be floatingly suspended and individually adjustable.

4. The striker system according to claim 2, wherein the first elevated section is adjustable in the longitudinal direction, lateral direction and/or vertical direction through deformation of the one or more first deformation elements and/or the one or more second deformation elements;
wherein the second elevated section is adjustable in the longitudinal direction, lateral direction and/or vertical direction through deformation of the one or more third deformation elements and/or the one or more fourth deformation elements.

5. The striker system according to claim 1, wherein the one or more first deformation elements are arranged as structural elements integrated with the first elevated section and the first attachment section, wherein the one or more second deformation elements are arranged as structural elements integrated with the first elevated section and the second attachment section, wherein the one or more third deformation elements are arranged as structural elements integrated with the second elevated section and the second attachment section, and wherein the one or more fourth deformation elements are arranged as structural elements integrated with the second elevated section and the third attachment section.

6. The striker system according to claim 2, wherein the bracket plate comprises two or more first deformation elements spaced apart in the lateral direction of the bracket plate, two or more second deformation elements spaced apart in the lateral direction of the bracket plate, two or more third deformation elements spaced apart in the lateral direction of the bracket plate, and two or more fourth deformation elements spaced apart in the lateral direction of the bracket plate.

7. The striker system according to claim 2, wherein in the assembled state, the first elevated section is brought in contact with the vehicle body through deformation of the one or more first deformation elements and the one or more second deformation elements; wherein in the assembled state, the second elevated section is brought in contact with the vehicle body through deformation of the one or more third deformation elements and the one or more fourth deformation elements.

8. The striker system according to claim 1, wherein the first attachment section, the second attachment section and the third attachment section are arranged on a first level in the vertical direction of the bracket plate, wherein in the attached state the first elevated section and the second elevated section are arranged on a second level in the vertical direction of the bracket plate different from the first level.

9. The striker system according to claim 1, wherein in the attached state, the first attachment section, the second attachment section and the third attachment section are arranged in connection to the vehicle body, wherein the first elevated section and the second elevated section are arranged at a distance from the vehicle body in the vertical direction of the bracket plate.

10. The striker system according to claim 1, wherein in the assembled state, the striker is arranged on a first side of a vehicle body element, and wherein the bracket plate is arranged on a second side of the vehicle body element.

11. The striker system according to claim 10, wherein the striker comprises a striker plate arranged in contact with the first side in the assembled state, wherein the striker plate comprises a first fastening opening arranged for receiving the first fastening element and a second fastening opening arranged for receiving the second fastening element;
wherein in the assembled state the first fastening element is extending from the first side to the second side via the first fastening opening, a first opening in the vehicle body element and the first fastening member,
wherein in the assembled state the second fastening element is extending from the first side to the second side via the second fastening opening, a second opening in the vehicle body element and the second fastening member.

12. The striker system according to claim 10, wherein in the assembled state, the first elevated section and the second elevated section are arranged in contact with the second side of the vehicle body element.

13. The striker system according to claim 1, wherein in the attached state, the bracket plate is connected to the vehicle body, wherein the first attachment section is attached to the vehicle body via one or more first attachment members, wherein the second attachment section is attached to the vehicle body via one or more second attachment members, wherein the third attachment section is attached to the vehicle body via one or more third attachment members.

14. The striker system according to claim 13, wherein the one or more first attachment members, the one or more second attachment members, and the one or more third attachment members, are arranged as welds.

15. The striker system according to claim 1, wherein the first fastening member is arranged as a first weld nut welded to an outer side of the first elevated section, wherein the second fastening member is arranged as a second weld nut welded to an outer side of the second elevated section.

16. A vehicle comprising the striker system according to claim 1.

17. A method for assembling a striker system according to claim 1 into an assembled state, wherein the method comprises the steps:
arranging the bracket plate in connection to the vehicle body in an attached state, wherein the first attachment section, the second attachment section and the third attachment section are attached to the vehicle body, wherein the first elevated section and the second elevated section are arranged at a distance from the vehicle body in the vertical direction;
engaging the first fastening element to the striker, and to the first fastening member of the first elevated section via the vehicle body, and engaging the second fastening element to the striker, and to the second fastening member of the second elevated section via the vehicle body, for connecting the striker to the bracket plate;
tightening the first fastening element for bringing the first elevated section in contact with the vehicle body through deformation of one or more first deformation elements connecting the first elevated section to the first attachment section and one or more second deformation elements connecting the first elevated section to the second attachment section, and tightening the second fastening element for bringing the second elevated section in contact with the vehicle body through deformation of one or more third deformation elements connecting the second elevated section to the second attachment section and one or more fourth deformation elements connecting the second elevated section to the third attachment section.
